(19) United States
(12) Patent Application Publication
(10) Pub. No.: US 2022/0229683 A1
(43) Pub. Date: Jul. 21, 2022

(54) MULTI-PROCESS VIRTUAL MACHINE MIGRATION IN A VIRTUALIZED COMPUTING SYSTEM

(71) Applicant: VMware, Inc., Palo Alto, CA (US)

(72) Inventors: Arunachalam RAMANATHAN, Union City, CA (US); Konstantinos ROUSSOS, Sunnyvale, CA (US); Gabriel TARASUK-LEVIN, San Francisco, CA (US); Derek William BEARD, Austin, TX (US)

(21) Appl. No.: 17/154,393

(22) Filed: Jan. 21, 2021

(51) Int. Cl. G06F 9/455; G06F 12/1009

(52) U.S. Cl. CPC G06F 9/45558; G06F 12/1009; G06F 2212/151; G06F 2009/45591; G06F 2009/4557

(57) ABSTRACT

Examples provide a method of migrating a multi-process virtual machine (VM) from at least one source host to at least one destination host in a virtualized computing system. The method includes: copying, by VM migration software executing in the at least one source host, guest physical memory of the multi-process VM to the at least one destination host; obtaining, by the VM migration software, at least one device checkpoint for at least one device supporting the multi-process VM, the multi-process VM including a user-level monitor (ULM) and at least one user-level driver (ULD), the at least one ULD interfacing with the at least one device, the ULM providing a virtual environment for the multi-process VM; transmitting the at least one device checkpoint to the at least one destination host; restoring the at least one device checkpoint; and resuming the multi-process VM on the at least one destination host.

### BACKGROUND

Computer virtualization is a technique that involves encapsulating a physical computing machine platform into virtual machine(s) executing under control of virtualization software on a hardware computing platform or “host.” A virtual machine (VM) provides virtual hardware abstractions for processor, memory, storage, and the like to a guest operating system. The virtualization software, also referred to as a “hypervisor,” includes one or more virtual machine monitors (VMMs) to provide execution environment(s) for the virtual machine(s). As physical hosts have grown larger, with greater processor core counts and terabyte memory sizes, virtualization has become key to the economic utilization of available hardware.

Virtualized computing systems can have multiple hosts managed by a virtualization management server. The virtualization management server can facilitate migration of a VM from one host to another host. A goal of such a migration is to move the VM from source host to destination host with minimal impact on VM performance. In such migration processes, the VM is implemented using a virtual machine monitor executing on a single host, where the virtual machine monitor provides all virtual devices, memory, and CPU. In some cases, a VM can be implemented using multiple processes, which can execute on one or more hosts. For example, a VM can include a virtual machine monitor process executing on one host and one or more driver processes executing on another host. There is a need to extend migration to be used with such multi-process VMs.

### SUMMARY

One or more embodiments provide a method of migrating a multi-process virtual machine (VM) from at least one source host to at least one destination host in a virtualized computing system. The method includes: copying, by VM migration software executing in the at least one source host, guest physical memory of the multi-process VM to the at least one destination host; obtaining, by the VM migration software, at least one device checkpoint for at least one device supporting the multi-process VM, the multi-process VM including a user-level monitor (ULM) and at least one user-level driver (ULD), the at least one ULD interfacing with the at least one device, the ULM providing a virtual environment for the multi-process VM; transmitting the at least one device checkpoint to the at least one destination host; restoring the at least one device checkpoint; and resuming the multi-process VM on the at least one destination host.

Further embodiments include a non-transitory computer-readable storage medium comprising instructions that cause a computer system to carry out the above method, as well as a computer system configured to carry out the above method. Though certain aspects are described with respect to VMs, they may be similarly applicable to other suitable physical and/or virtual computing instances.

### BRIEF DESCRIPTION OF THE DRAWINGS

FIG. 1 is a block diagram depicting a virtualized computing system according to an embodiment.

FIG. 2 is a block diagram depicting a multi-process VM executing in a virtualized computing system according to an embodiment.

FIG. 3 is a flow diagram depicting a method of migrating a component of a multi-process VM according to an embodiment.

FIG. 4 is a flow diagram depicting a method of migrating a multi-process VM according to an embodiment.

FIG. 5 is a block diagram depicting migration of a multi-process VM from a source to a destination according to an embodiment.

FIG. 6 is a flow diagram depicting a method of migrating the multi-process VM shown in FIG. 5 according to an embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for multi-process VM migration in a virtualized computing system are described. VM migration involves migrating a running a multi-process VM in at least one first host to at least one second host with minimal impact on the guest software executing in the multi-process VM. Each host is virtualized with a hypervisor managing VMs. The multi-process VM is implemented by a plurality of processes, including a user-level monitor (ULM) and at least one user-level driver (ULD). In some embodiments, the ULM and ULD(s) execute on the same host. in other embodiments, the ULD executes on a separate host from the ULM. In embodiments, the LTM is managed by a first kernel executing on a central processing unit (CPU), and the LTD is managed by a second kernel executing on a device. These and further aspects are discussed below with respect to the drawings.

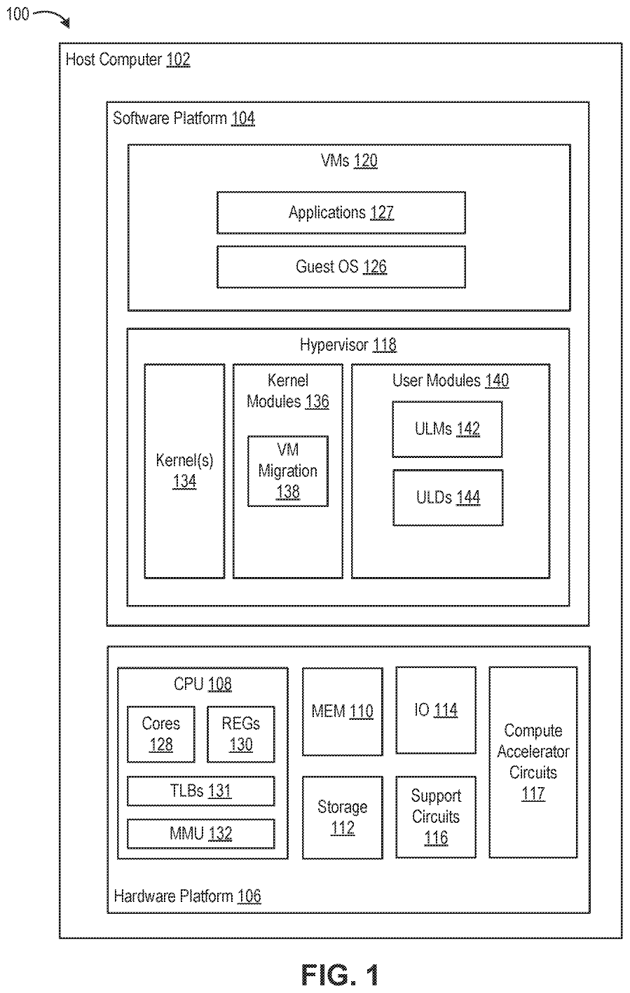

FIG. 1 is a block diagram depicting a virtualized computing system 100 according to an embodiment. Virtualized computing system 100 includes a host computer 102 having a software platform 104 executing on a hardware platform 106. Hardware platform 106 may include conventional components of a computing device, such as a central processing unit (CPU) 108, system memory (MEM) 110, a storage system (storage) 112, input/output devices (TO) 114, various support circuits 116, and optionally compute accelerator circuits 117. CPU 108 is configured to execute instructions, for example, executable instructions that perform one or more operations described herein and may be stored in system memory 110 and storage system 112. System memory 110 is a device allowing information, such as executable instructions, virtual disks, configurations, and other data, to be stored and retrieved. System memory 110 may include, for example, one or more random access memory (RAM) modules. In embodiments, system memory 110 can include disaggregated memory (also referred to as “cluster memory”), which is memory remotely accessible by another host computer. For example, a VM in another host computer can be assigned memory from the cluster memory. Storage system 112 includes local storage devices (e.g., one or more hard disks, flash memory modules, solid state disks, and optical disks) and/or a storage interface that enables host computer 102 to communicate with one or more network data storage systems. Examples of a storage interface are a host bus adapter (HBA) that couples host computer 102 to one or more storage arrays, such as a storage area network (SAN) or a network-attached storage (NAS), as well as other network data storage systems. Storage 112 in multiple hosts 102 can be aggregated and provisioned as part of shared storage accessible through a physical network (not shown). Input/output devices 114 include conventional interfaces known in the art, such as one or more network interfaces. Support circuits 116 include conventional cache, power supplies, clock circuits, data registers, and the like. Compute accelerator circuits 117 include graphic processing units (GPUs), field programmable gate arrays (FPGAs), and the like.

CPU 108 includes one or more cores 128, various registers 130, and a memory management unit (MMU) 132. Each core 128 is a microprocessor, such as an x86 microprocessor. Registers 130 include program execution registers for use by code executing on cores 128 and system registers for use by code to configure CPU 108. Code is executed on CPU 108 at a privilege level selected from a set of privilege levels. For example, x86 microprocessors from Intel Corporation include four privilege levels ranging from level 0 (most privileged) to level 3 (least privileged). Privilege level 3 is referred to herein as “a user privilege level” and privilege levels 0, 1, and 2 are referred to herein as “supervisor privilege levels.” Code executing at the user privilege level is referred to as user-mode code. Code executing at a supervisor privilege level is referred to as supervisor-mode code or kernel-mode code. Other CPUs can include a different number of privilege levels and a different numbering scheme. In CPU 108, at least one register 130 stores a current privilege level (CPL) of code executing thereon.

MMU 132 supports paging of system memory 110. Paging provides a “virtual memory” environment where a virtual address space is divided into pages, which are either stored in system memory 110 or in storage 112. “Pages” are individually addressable units of memory. Each page (also referred to herein as a “memory page”) includes a plurality of separately addressable data words, each of which in turn includes one or more bytes. Pages are identified by addresses referred to as “page numbers.” CPU 108 can support multiple page sizes. For example, modern x86 CPUs can support 4 kilobyte (KB), 2 megabyte (MB), and 1 gigabyte (GB) page sizes. Other CPUs may support other page sizes.

MMU 132 translates virtual addresses in the virtual address space (also referred to as virtual page numbers) into physical addresses of system memory 110 (also referred to as machine page numbers). MMU 132 also determines access rights for each address translation. An executive (e.g., operating system, hypervisor, etc.) exposes page tables to CPU 108 for use by MMU 132 to perform address translations. Page tables can be exposed to CPU 108 by writing pointer(s) to control registers and/or control structures accessible by MMU 132. Page tables can include different types of paging structures depending on the number of levels in the hierarchy. A paging structure includes entries, each of which specifies an access policy and a reference to another paging structure or to a memory page. Translation lookaside buffer (TLB) 131 to caches address translations for MMU 132. MMU 132 obtains translations from TLB 131 if valid and present. Otherwise, MMU 132 “walks” page tables to obtain address translations. CPU 108 can include an instance of MMU 132 and TLB 131 for each core 128.

CPU 108 can include hardware-assisted virtualization features, such as support for hardware virtualization of MMU 132. For example, modern x86 processors commercially available from Intel Corporation include support for MMU virtualization using extended page tables (EPTs). Likewise, modern x86 processors from Advanced Micro Devices, Inc. include support for MMU virtualization using Rapid Virtualization Indexing (RVI). Other processor platforms may support similar MMU virtualization. In general, CPU 108 can implement hardware MMU virtualization using nested page tables (NPTs). In a virtualized computing system, a guest OS in a VM maintains page tables (referred to as guest page tables) for translating virtual addresses to physical addresses for a VM memory provided by the hypervisor (referred to as guest physical addresses). The hypervisor maintains NPTs that translate guest physical addresses to physical addresses for system memory 110 (referred to as machine addresses). Each of the guest OS and the hypervisor exposes the guest paging structures and the NPTs, respectively, to the CPU 108. MMU 132 translates virtual addresses to machine addresses by walking the guest page structures to obtain guest physical addresses, which are used to walk the NPTs to obtain machine addresses.

Software platform 104 includes a virtualization layer that abstracts processor, memory, storage, and networking resources of hardware platform 106 into one or more virtual machines (“VMs”) that run concurrently on host computer 102. The VMs run on top of the virtualization layer, referred to herein as a hypervisor, which enables sharing of the hardware resources by the VMs. In the example shown, software platform 104 includes a hypervisor 118 that supports VMs 120. One example of hypervisor 118 that may be used in an embodiment described herein is a VMware ESXi™ hypervisor provided as part of the VMware vSphere® solution made commercially available from VMware, Inc. of Palo Alto, Calif. (although it should be recognized that any other virtualization technologies, including Xen® and Microsoft Hyper-V® virtualization technologies may be utilized consistent with the teachings herein). Hypervisor 118 includes one or more kernels 134, kernel modules 136, and user modules 140. In embodiments, kernel modules 136 include VM migration software 138. In embodiments, user modules 140 include user-level monitors (ULMs) 142 and user-level drivers (ULDs) 144.

Each VM 120 includes guest software (also referred to as guest code) that runs on the virtualized resources supported by hardware platform 106. In the example shown, the guest software of VM 120 includes a guest OS 126 and client applications 127. Guest OS 126 can be any commodity operating system known in the art (e.g., Linux®, Windows®, etc.). Client applications 127 can be any applications executing on guest OS 126 within VM 120.

Each kernel 134 provides operating system functionality (e.g., process creation and control, file system, process threads, etc.). A kernel 134 executes on CPU 108 and provides CPU scheduling and memory scheduling across guest software in VMs 120, kernel modules 136, and user modules 140. In embodiments, a kernel 134 can execute on other processor components in host computer 102, such as on a compute accelerator circuit 117 (e.g., on an FPGA), an IO circuit 114 (e.g., on a network interface card), or the like. Thus, in embodiments, hypervisor 118 includes multiple kernels executing on disparate processing circuits in host computer 102. A VM 120 can consume devices that are spread across multiple kernels 134 (e.g., CPU 108, IO 114, and computer accelerator circuits 117).

User modules 140 comprise processes executing in user-mode within hypervisor 118. ULMs 140 implement the virtual system support needed to coordinate operations between hypervisor 118 and VMs 120. ULMs 140 execute in user mode, rather than kernel mode (such as a virtual machine monitor (VMM)). Each ULM 142 manages a corresponding virtual hardware platform that includes emulated hardware, such as virtual CPUs (vCPUs) and guest physical memory (also referred to as VM memory). Each virtual hardware platform supports the installation of guest software in a corresponding VM 120. ULDs 144 include software drivers for various devices, such as IO 114, storage 112, and compute accelerator circuits 117. Kernel modules 136 comprise processes executing in kernel-mode within hypervisor 118. In an embodiment, kernel modules 136 include a VM migration module 138. VM migration module is configured to manage migration of VMs from host computer 102 to another host computer or from another host computer to host computer 102 as described further herein. In other embodiments, VM migration module 138 can be a user module.

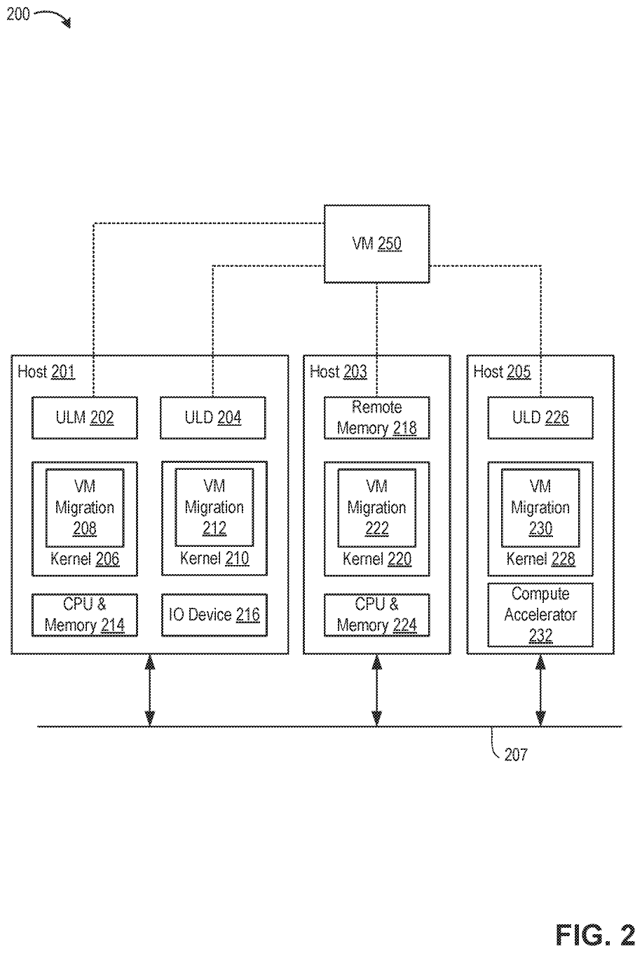

FIG. 2 is a block diagram depicting a VM 250 executing in a virtualized computing system 200 according to an embodiment. Virtualized computing system includes hosts 201, 203, and 205, each constructed the same or similar to host computer 102 shown in FIG. 1. VM 250 executes in host 201, but is shown as a logically separate entity for purposes of example. Host 201 includes a ULM 202 and a ULD 204. ULM 202 is managed by kernel 206, which in turn executes on CPU and memory 214 of host 201. ULM provides a virtual environment for VM 250. ULD 204 is managed by a kernel 210, which in turn executes on an IO device 216 (e.g., a NIC). ULD 204 provides a software interface to IO device 216 for VM 250. Host 203 includes remote memory 218 and a kernel 220. Kernel 220 executes on CPU and memory 224 of host 203. VM 250 includes guest physical memory that is backed by machine memory in remote memory 218. Host 205 includes a ULD 226 managed by a kernel 228, which in turn executes on a compute accelerator 232. ULD provides a software interface to compute accelerator 232 for VM 250. Hosts 201, 203, and 205 are coupled to a network 207. Each kernel supports VM migration software executing in kernel mode, including VM migration software 208, 212, 222, and 230 managed by kernels 206, 210, 220, and 228, respectively.

Thus, in the example of FIG. 2, VM 250 is a multi-process VM in that VM 250 is supported by multiple processes executing in multiple hosts. In general, a “multi-process” VM encompasses VMs supported by multiple user-level and/or kernel level processes, which execute in one or more host computers. Multi-process VMs are distinct from conventional VMs, which are supported by a VMM that provides virtual infrastructure for the VM.

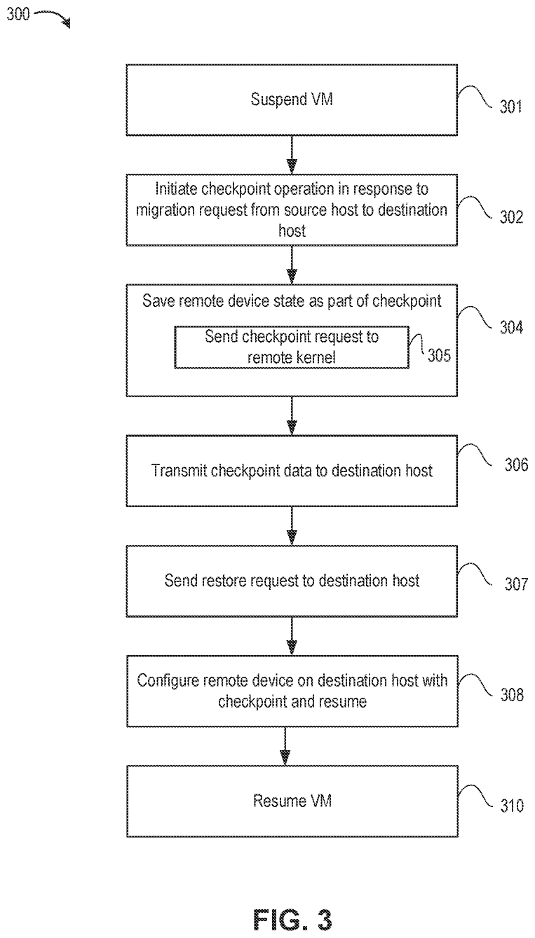

FIG. 3 is a flow diagram depicting a method 300 of migrating a component of a multi-process VM according to an embodiment. In the example, the multi-process VM includes ULM 202 executing on CPU and memory 214, ULD 204 executing on IO device 216, and ULD 226 executing on compute accelerator 232. The migrated component is ULD 226, which is migrated from a source host (host 205) to a destination host (e.g., another host in the cluster having a compute accelerator).

Method 300 begins at step 301, where VM migration software 208 suspends VM 250. At step 302, VM migration software 208 initiates a checkpoint operation in response to a migration request. In embodiments, the checkpoint is for the device that is being migrated and not for the entire VM. At step 304, VM migration software 230 saves the device state maintained by ULD 226 for the remote device used by VM 250 (e.g., compute accelerator 232). For example, at step 305, VM migration software 208 in kernel 206 sends a checkpoint save request to VM migration software 230 in kernel 228. At step 306, VM migration software 230 transmits the checkpoint data (e.g., device state maintained by ULD 226) to VM migration software in the destination host. At step 307, VM migration software 208 commands the VM migration software in the destination host to restore the checkpoint data (device state) to the ULD in the destination host. At step 308, the VM migration software in the destination host configures the remote device (e.g., compute accelerator) with the device state in the checkpoint and resumes the device. At step 310, VM migration software 208 resumes VM 250. Note that in a traditional VM migration, step 310 is not present, since the destination VM will start running automatically after restore. However, in the embodiment of FIG. 3, there is no destination VM and only a destination ULD. So VM 250 is resumed after the migration.

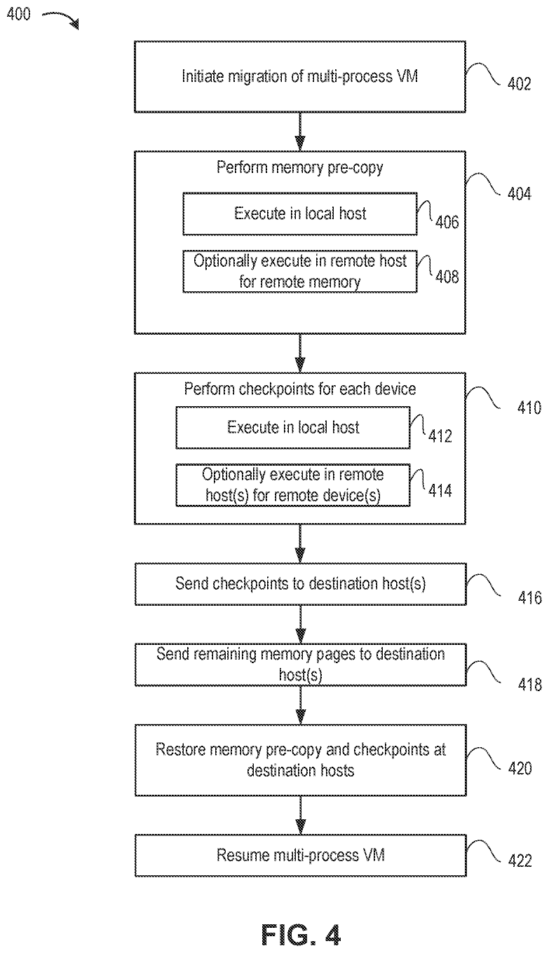

FIG. 4 is a flow diagram depicting a method 400 of migrating a multi-process VM according to an embodiment. In the example, the multi-process VM is as shown in FIG. 2. Method 400 begins at step 402, where VM migration software 208 initiates migration of VM 250. As shown in FIG. 2, VM 250 is implemented by multiple processes, including ULM 202, ULD 204, and ULD 226. VM 250 further includes guest physical memory from both CPU and memory 214 and remote memory 218 (as part of CPU and memory 224). At step 404, VM migration software 208 performs a memory pre-copy operation. The memory pre-copy operation includes several iterations of copying the guest physical memory of VM 250 while VM 250 continues to execute. In an embodiment, the memory pre-copy process is executed in the local host of VM 250, that is, the host that executes the ULM (e.g., host 201 executing ULM 202). In some embodiments, as in the example described herein, VM 250 includes remote memory (e.g., remote memory 218). Thus, at step 408, the memory pre-copy process is also executed in the remote host (e.g., by VM migration software 222 in host 203 having remote memory 218 for VM 250).

At step 410, VM migration software 208 initiates checkpoints for each device supporting VM 250. The process for migrating a device supporting a multi-process VM is described above in FIG. 3. The device can be local (e.g., in host 201) or remote (e.g., in host 205) or both. Thus, at step 412, device checkpoint(s) are taken in the local host (e.g., host 201). At optional step 414, device checkpoints are taken at remote host(s) for remote device(s) (e.g., host 205 for compute accelerator 232 supported by ULD 226).

At step 416, VM migration software 208 initiates the transfer of the device checkpoints to the destination hosts. In this case, there are three destination hosts, one for ULM 202 and ULD 204, another for remote memory 218, and yet another for ULD 226. At step 418, VM migration software 208 transfers any remaining memory pages not transferred during pre-copy to the destination host(s). At step 420, VM migration software 208 commands the restoration of memory pre-copy and device checkpoints in the destination host(s). At step 422, VM migration software in the destination hosts resume the processes of the multi-process VM (e.g., ULM 202, ULD 204, and ULD 226).

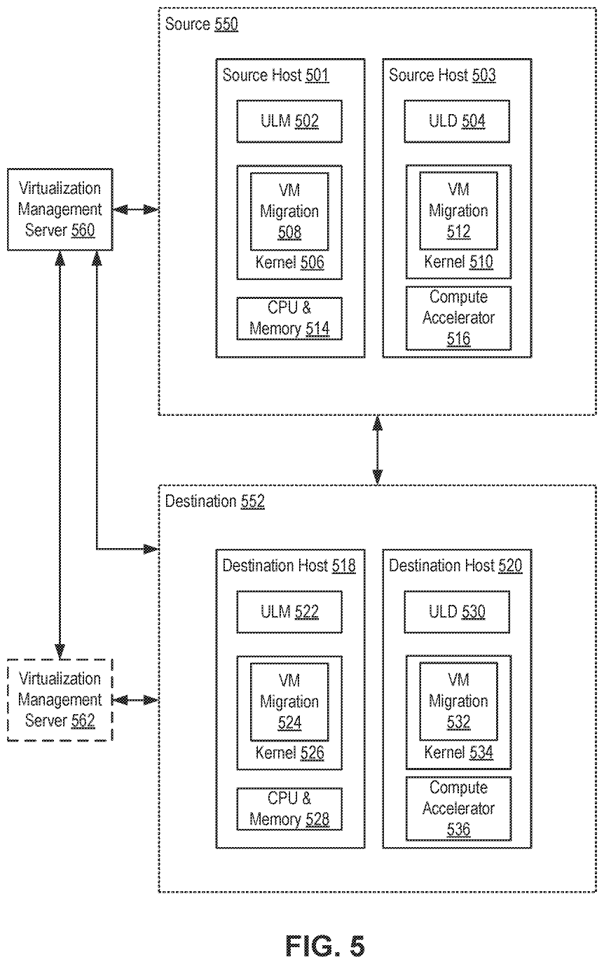

FIG. 5 is a block diagram depicting migration of a multi-process VM from a source 550 to a destination 552 according to an embodiment. In an embodiment, both source 550 and destination 552 are managed by a single virtualization management server 560. In another embodiment, each of source 550 and destination 552 are managed by a separate virtualization management server 560, 562. Source 550 includes source host 501 and source host 503. Destination 552 includes destination host 518 and destination host 520. Each of hosts 501, 503, 518, and 520 is constructed the same or similar to host computer 102 shown in FIG. 1. The VM includes ULM 502 executing in host 501 and ULD 504 executing in host 503. Host 501 includes a kernel 506 executing VM migration software 508 on CPU and memory 514. Host 503 includes a kernel 510 executing VM migration software 512 on a compute accelerator 516. The migrated VM includes ULM 522 and ULD 530. ULM 522 is a migrated instance of ULM 502. ULD 530 is a migrated instance of ULD 504. Destination host 518 includes kernel 526 executing VM migration software 524 on CPU and memory 528. Destination host 530 includes kernel 534 executing VM migration software 532 on compute accelerator 536.

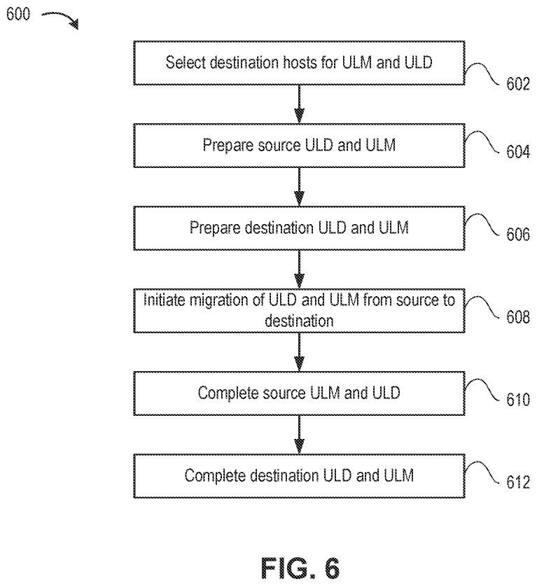

FIG. 6 is a flow diagram depicting a method 600 of migrating the multi-process VM shown in FIG. 5 according to an embodiment. Method 600 begins at step where virtualization management server 560 (in cooperation with virtualization management server 562 if present) selects destination hosts 518 and 520 for migrating ULM 502 and ULD 504 of the VM. At step 604, virtualization management server 560 prepares ULM 502 and ULD 504 in source 550. For example, virtualization management server 560 can prepare ULM 502 by setting a VM file lock to read only. Virtualization management server 560 can prepare ULD 504 by running ULD 504 in migration mode. At step 606, virtualization management server 560 prepares destination hosts 518 and 520 for ULM 522 and ULD 530, respectively. For example, virtualization management server 560 (in cooperation with virtualization management server 562 if present) allocates resources for ULM 522 and ULD 530.

At step 608, virtualization management server 560 initiates migration of ULM 502 and ULD 504 from source 550 to destination 552. Migration of a multi-process VM is discussed above with respect to FIGS. 2-4. At step 610, virtualization management server 560 completes ULM 502 and ULD 504. For example, virtualization management server 560 unregisters and powers off the VM, and frees the device state. At step 612, virtualization management server 560 (or virtualization management server 562 if present) completes ULM 522 and ULD 530. For example, the virtualization management server registers the VM and device as part of a multi-process VM.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of migrating a multi-process virtual machine (VM) from at least one source host to at least one destination host in a virtualized computing system, the method comprising:
copying, by VM migration software executing in the at least one source host, guest physical memory of the multi-process VM to the at least one destination host;
obtaining, by the VM migration software, at least one device checkpoint for at least one device supporting the multi-process VM, the multi-process VM including a user-level monitor (ULM) and at least one user-level driver (ULD), the at least one ULD interfacing with the at least one device, the ULM providing a virtual environment for the multi-process VM;
transmitting the at least one device checkpoint to the at least one destination host;
restoring the at least one device checkpoint; and
resuming the multi-process VM on the at least one destination host.

2. The method of claim 1, wherein the at least one source host comprises a first source host, where the ULM is managed by a first kernel executing on a central processing unit (CPU) of the first source host, and where the ULD is managed by a second kernel executing on a first device of the at least one device.

3. The method of claim 2, wherein the at least one destination host comprises a first destination host for executing the ULM and the ULD.

4. The method of claim 1, wherein the at least one source host comprises a first source host and a second source host, wherein the ULM is managed by a first kernel executing on a central processing unit (CPU) of the first source host, and wherein the ULD is managed by a second kernel executing on a first device of the at least one device, the first device disposed in the second source host.

5. The method of claim 4, wherein the at least one destination host includes a first destination host for executing the ULM and a second destination host for executing the ULD.

6. The method of claim 1, wherein the guest physical memory is backed by first machine memory in a first source host, the first source host executing the ULM.

7. The method of claim 6, wherein the guest physical memory is backed by second machine memory in a second source host.

8. A non-transitory computer readable medium having instructions stored thereon that when executed by a processor cause the processor to perform a method of migrating a multi-process virtual machine (VM) from at least one source host to at least one destination host in a virtualized computing system, the method comprising:
copying, by VM migration software executing in the at least one source host, guest physical memory of the multi-process VM to the at least one destination host;
obtaining, by the VM migration software, at least one device checkpoint for at least one device supporting the multi-process VM, the multi-process VM including a user-level monitor (ULM) and at least one user-level driver (ULD), the at least one ULD interfacing with the at least one device, the ULM providing a virtual environment for the multi-process VM;
transmitting the at least one device checkpoint to the at least one destination host;
restoring the at least one device checkpoint; and
resuming the multi-process VM on the at least one destination host.

9. The non-transitory computer readable medium of claim 8, wherein the at least one source host comprises a first source host, where the ULM is managed by a first kernel executing on a central processing unit (CPU) of the first source host, and where the ULD is managed by a second kernel executing on a first device of the at least one device.

10. The non-transitory computer readable medium of claim 9, wherein the at least one destination host comprises a first destination host for executing the ULM and the ULD.

11. The non-transitory computer readable medium of claim 8, wherein the at least one source host comprises a first source host and a second source host, wherein the ULM is managed by a first kernel executing on a central processing unit (CPU) of the first source host, and wherein the ULD is managed by a second kernel executing on a first device of the at least one device, the first device disposed in the second source host.

12. The non-transitory computer readable medium of claim 11, wherein the at least one destination host includes a first destination host for executing the ULM and a second destination host for executing the ULD.

13. The non-transitory computer readable medium of claim 8, wherein the guest physical memory is backed by first machine memory in a first source host, the first source host executing the ULM.

14. The non-transitory computer readable medium of claim 13, wherein the guest physical memory is backed by second machine memory in a second source host.

15. A virtualized computing system, comprising:
at least one source host executing a multi-process virtual machine (VM); and
at least one destination host configured to execute the multi-process VM after migration thereof from the at least one source host;
wherein the at least one source host executes VM migration software configured to:
copy guest physical memory of the multi-process VM to the at least one destination host;
obtain at least one device checkpoint for at least one device supporting the multi-process VM, the multi-process VM including a user-level monitor (ULM) and at least one user-level driver (ULD), the at least one ULD interfacing with the at least one device, the ULM providing a virtual environment for the multi-process VM;
transmit the at least one device checkpoint to the at least one destination host;
restore the at least one device checkpoint; and
resume the multi-process VM on the at least one destination host.

16. The virtualized computing system of claim 15, wherein the at least one source host comprises a first source host, where the ULM is managed by a first kernel executing on a central processing unit (CPU) of the first source host, and where the ULD is managed by a second kernel executing on a first device of the at least one device.

17. The virtualized computing system of claim 16, wherein the at least one destination host comprises a first destination host for executing the ULM and the ULD.

18. The virtualized computing system of claim 15, wherein the at least one source host comprises a first source host and a second source host, wherein the ULM is managed by a first kernel executing on a central processing unit (CPU) of the first source host, and wherein the ULD is managed by a second kernel executing on a first device of the at least one device, the first device disposed in the second source host.

19. The virtualized computing system of claim 18, wherein the at least one destination host includes a first destination host for executing the ULM and a second destination host for executing the ULD.

20. The virtualized computing system of claim 15, wherein the guest physical memory is backed by first machine memory in a first source host, the first source host executing the ULM, and second machine memory in a second source host.
